(19) United States
(12) Patent Application Publication
(10) Pub. No.: US 2014/0030496 A1
(43) Pub. Date: Jan. 30, 2014

(54) WINDOW STRUCTURE FOR PROTECTING A DISPLAY PANEL

(71) Applicant: SAMSUNG DISPLAY CO., LTD., Yongin-City (KR)

(72) Inventors: Jee-Seok OH, Yongin-City (KR); Sung-Jin HWANG, Yongin-City (KR); Hyoung-Suk ROH, Yongin-City (KR); Sang-Gu KIM, Yongin-City (KR)

(73) Assignee: SAMSUNG DISPLAY CO., LTD., Yongin-City (KR)

(21) Appl. No.: 13/759,190

(22) Filed: Feb. 5, 2013

(30) Foreign Application Priority Data
Jul. 27, 2012 (KR) 10-2012-0082225

(51) Int. Cl. B32B 7/12; B32B 37/12; B32B 27/32; B32B 5/00; B32B 27/36

(52) U.S. Cl. CPC B32B 7/12; B32B 5/00; B32B 27/365; B32B 27/32; B32B 37/12
USPC 428/214; 428/411.1; 428/412; 428/500; 156/60

(57) ABSTRACT

A window structure that includes first, second and third light transparent films sequentially stacked on a display panel. The window structure also includes a first adhesive layer structure having a first adhesive layers between the first and second light transparent films, and a second adhesive layer structure having a second adhesive layers between the second and third light transparent films.

### CLAIM OF PRIORITY

This application makes reference to, incorporates the same herein, and claims all benefits accruing under 35 U.S.C.§119 from an application earlier filed in the Korean Intellectual Property Office on 27 Jul. 2012 and there duly assigned Serial No. 10-2012-0082225.

### BACKGROUND OF THE INVENTION

1. Field of the Invention

Examplary embodiments of the present invention generally relates to a window structure and a method of manufacturing the same.

2. Description of the Related Art

A window may be formed on a display panel used in a mobile phone, a portable multimedia player (PMP), etc., and protect the display panel. Conventionally, tempered glass has been used for the window, but recently goods made of plastic instead of tempered glass have been developed.

The above information disclosed in this Related Art section is only for enhancement of understanding of the background of the invention and therefore it may contain information that does not form the prior art that is already known to a person of ordinary skill in the art.

### SUMMARY OF THE INVENTION

Examplary embodiments provide a window structure for protecting a display panel having an enhanced strength.

Examplary embodiments provide a display panel assembly including a window structure for protecting a display panel having an enhanced strength.

Examplary embodiments provide a method of manufacturing a window structure for protecting a display panel having an enhanced strength.

Examplary embodiments provide a method of manufacturing a display panel assembly using a method of manufacturing a window structure for protecting a display panel made of plastic having an enhanced strength.

According to one aspect of examplary embodiments, there is provided a window structure. The window structure includes first, second and third light transparent films sequentially stacked on a display panel, a first adhesive layer structure including a plurality of first adhesive layers between the first and second light transparent films, and a second adhesive layer structure including a plurality of second adhesive layers between the second and third light transparent films.

In examplary embodiments, the plurality of first adhesive layers may have substantially the same thickness, and the plurality of second adhesive layers may have substantially the same thickness.

In examplary embodiments, the first and second adhesive layers may have substantially the same thickness.

In examplary embodiments, the first and second adhesive layer structures may have two first adhesive layers and two second adhesive layers, respectively

In examplary embodiments, one of the first adhesive layers adjacent to the second light transparent film may have a thickness greater than that of the other of the first adhesive layers adjacent to the first light transparent film, and one of the second adhesive layers adjacent to the second light transparent film may have a thickness greater than that of the other of the second adhesive layers adjacent to the third light transparent film.

In examplary embodiments, the plurality of first adhesive layers may have substantially the same material, and the plurality of second adhesive layers may have substantially the same material.

In examplary embodiments, the first and second adhesive layers may include substantially the same material.

In examplary embodiments, the first and second adhesive layers may include optically clear adhesive (OCA) or super view resin (SVR).

In examplary embodiments, the first and second adhesive layers may include pressure sensitive adhesive (PSA).

In examplary embodiments, the first and third light transparent films may have substantially the same material, and the second light transparent film may have a material different from that of the first and third light transparent films.

In examplary embodiments, the first and third light transparent films may include silplus, and the second light transparent film may include polycarbonate (PC), polyethylene terephthalate (PET) or polymethyl methacrylate (PMMA).

According to another aspect of examplary embodiments, there is provided a display panel assembly. The display panel includes a display panel and a window structure protecting the display panel. The window structure includes first, second and third light transparent films sequentially stacked on the display panel, a first adhesive layer structure including a plurality of first adhesive layers between the first and second light transparent films, and a second adhesive layer structure including a plurality of second adhesive layers between the second and third light transparent films.

In examplary embodiments, the second adhesive layer structure may have two first adhesive layers and two second adhesive layers, respectively, and the first and second adhesive layers may have substantially the same thickness.

In examplary embodiments, the first and second adhesive layers may have two first adhesive layers and two second adhesive layers, respectively, one of the first adhesive layers adjacent to the second light transparent film may have a thickness greater than that of the other of the first adhesive layers adjacent to the first light transparent film, and one of the second adhesive layers adjacent to the second light transparent film may have a thickness greater than that of the other of the second adhesive layers adjacent to the third light transparent film.

In examplary embodiments, the first and second adhesive layers may include PSA, the first and third light transparent films may include silplus, and the second light transparent film includes PC, PET or PMMA.

According to still another aspect of examplary embodiments, there is provided a method of manufacturing a window structure for protecting a display panel. In the method, a first adhesive layer structure including a plurality of first adhesive layers may be adhered to a first light transparent film. A second light transparent film may be adhered to the first adhesive layer structure. A second adhesive layer structure including a plurality of second adhesive layers may be adhered to the second light transparent film. A third light transparent may be adhered to the second adhesive layer structure.

In examplary embodiments, when the first and second adhesive layer structures are adhered to the first and second light transparent films, respectively, two first adhesive layers and two second adhesive layers may be formed, and the first and second adhesive layers may be formed to have substantially the same thickness.

In examplary embodiments, when the first and second adhesive layer structures are adhered to the first and second light transparent films, respectively, two first adhesive layers and two second adhesive layers may be formed. A thinner one of the first adhesive layers may be adhered to a top surface of the first light transparent film, and a thicker one of the first adhesive layers may be adhered to a bottom surface of the second light transparent film. A thicker one of the second adhesive layers may be adhered to a top surface of the second light transparent film, and a thinner one of the second adhesive layers may be adhered to a bottom surface of the third light transparent film.

In examplary embodiments, the first and second adhesive layers may be formed to include PSA, the first and third light transparent films may be formed to include silplus, and the second light transparent film may be formed to include PC, PET or PMMA.

According to still another aspect of examplary embodiments, there is provided a method of manufacturing a display panel assembly. In the method, a first adhesive layer structure including a plurality of first adhesive layers may be adhered to a first light transparent film. A second light transparent film may be adhered to the first adhesive layer structure. A second adhesive layer structure including a plurality of second adhesive layers may be adhered to the second light transparent film. A third light transparent may be adhered to the second adhesive layer structure. The first light transparent film may be adhered to a display panel.

In examplary embodiments, when the first and second adhesive layer structures are adhered to the first and second light transparent films, respectively, two first adhesive layers and two second adhesive layers may be formed, and the first and second adhesive layers may be formed to have substantially the same thickness.

In examplary embodiments, when the first and second adhesive layer structures are adhered to the first and second light transparent films, respectively, two first adhesive layers and two second adhesive layers may be formed. A thinner one of the first adhesive layers may be adhered to a top surface of the first light transparent film, and a thicker one of the first adhesive layers may be adhered to a bottom surface of the second light transparent film. A thicker one of the second adhesive layers may be adhered to a top surface of the second light transparent film, and a thinner one of the second adhesive layers may be adhered to a bottom surface of the third light transparent film.

In examplary embodiments, the first and second adhesive layers may be formed to include PSA, the first and third light transparent films may be formed to include silplus, and the second light transparent film may be formed to include PC, PET or PMMA.

The window structure in accordance with examplary embodiments may include the plurality of light transparent films, and the first and second adhesive layer structures including the plurality of first adhesive layers and the plurality of second adhesive layers, respectively. Thus, the window structure may have an enhanced strength and impact resistance.

The window structure may have the enhanced strength and impact resistance, so that the display panel covered by the window structure may be sufficiently protected, and the display panel assembly including the display panel and the window structure may have a stable structure.

### BRIEF DESCRIPTION OF THE DRAWINGS

A more complete appreciation of the invention, and many of the attendant advantages thereof, will be readily apparent as the same becomes better understood by reference to the following detailed description when considered in conjunction with the accompanying drawings, in which like reference symbols indicate the same or similar components, wherein:

FIG. 1 is a cross-sectional view illustrating a first display panel assembly including a first window structure for protecting a display panel in accordance with examplary embodiments;

FIGS. 2 to 4 are cross-sectional views illustrating a method of manufacturing a first display panel assembly including a first window structure for protecting a display panel;

FIGS. 5 and 6 are cross-sectional views illustrating a method of manufacturing a first display panel assembly including a first window structure for protecting a display panel;

FIG. 7 is a second display panel assembly including a second window structure for protecting a display panel in accordance with examplary embodiments;

FIG. 8 is a third display panel assembly including a third window structure for protecting a display panel in accordance with Comparative Example; and

FIG. 9 is a graph illustrating the strength of the first, second, third and fourth window structures.

### DETAILED DESCRIPTION OF THE INVENTION

The examplary embodiments are described more fully hereinafter with reference to the accompanying drawings. The invention may, however, be embodied in many different forms and should not be construed as limited to the examplary embodiments set forth herein. In the drawings, the sizes and relative sizes of layers and regions may be exaggerated for clarity.

It will be understood that when an element or layer is referred to as being “on,” “connected to” or “coupled to” another element or layer, it can be directly on, connected or coupled to the other element or layer or intervening elements or layers may be present. In contrast, when an element is referred to as being “directly on,” “directly connected to” or “directly coupled to” another element or layer, there are no intervening elements or layers present. Like or similar reference numerals refer to like or similar elements throughout. As used herein, the term “and/or” includes any and all combinations of one or more of the associated listed items.

It will be understood that, although the terms first, second, third etc. may be used herein to describe various elements, components, regions, layers, patterns and/or sections, these elements, components, regions, layers, patterns and/or sections should not be limited by these terms. These terms are only used to distinguish one element, component, region, layer pattern or section from another region, layer, pattern or section. Thus, a first element, component, region, layer or section discussed below could be termed a second element, component, region, layer or section without departing from the teachings of examplary embodiments.

Spatially relative terms, such as “beneath,” “below,” “lower,” “above,” “upper” and the like, may be used herein for ease of description to describe one element or feature's relationship to another element(s) or feature(s) as illustrated in the figures. It will be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the exemplary term “below” can encompass both an orientation of above and below. The device may be otherwise oriented (rotated 90 degrees or at other orientations) and the spatially relative descriptors used herein interpreted accordingly.

The terminology used herein is for the purpose of describing particular examplary embodiments only and is not intended to be limiting of the invention. As used herein, the singular forms “a,” “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Examplary embodiments are described herein with reference to cross sectional illustrations that are schematic illustrations of illustratively idealized examplary embodiments (and intermediate structures) of the invention. As such, variations from the shapes of the illustrations as a result, for example, of manufacturing techniques and/or tolerances, are to be expected. Thus, examplary embodiments should not be construed as limited to the particular shapes of regions illustrated herein but are to include deviations in shapes that result, for example, from manufacturing. The regions illustrated in the figures are schematic in nature and their shapes are not intended to illustrate the actual shape of a region of a device and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

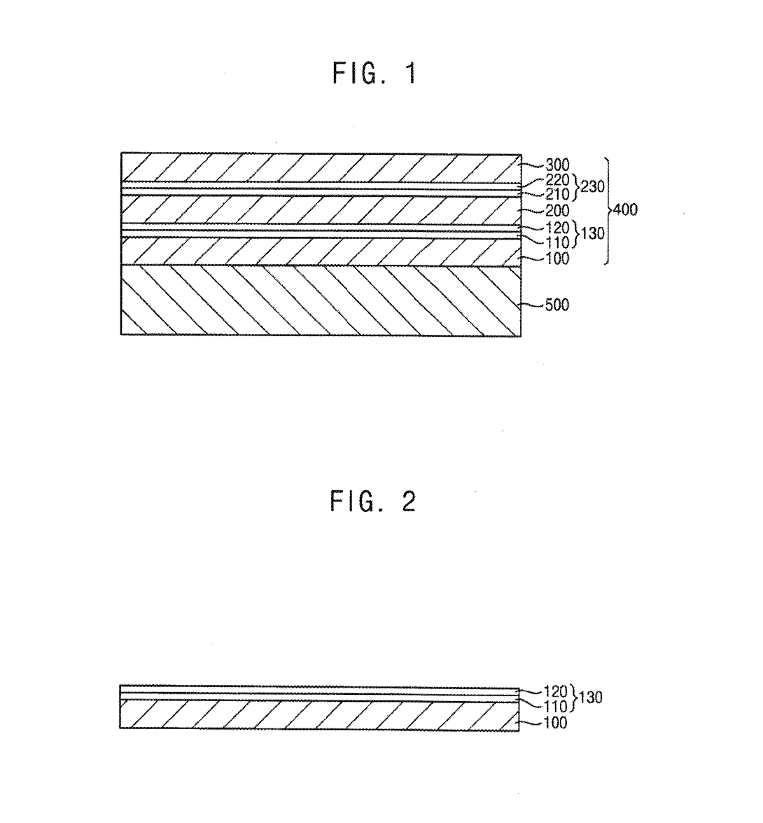

FIG. 1 is a cross-sectional view illustrating a first display panel assembly including a first window structure for protecting a display panel in accordance with examplary embodiments.

Referring to FIG. 1, the first display panel assembly may include a display panel 500 and a first window structure 400 on the display panel 500.

The display panel 500 may be, e.g., an organic light emitting diode (OLED) display panel, a liquid crystal display (LCD) panel, a plasma display panel, etc.

The first window structure 400 may be formed on the display panel 500 and protect the display panel 500. The first window structure 400 may be adhered to the display panel 500 by a light transparent adhesive (not shown), e.g., super view resin (SVR).

In examplary embodiments, the first window structure 400 may include first, second and third transparent films 100, 200 and 300, a first adhesive layer structure 130 between the first and second transparent films 100 and 200, and a second adhesive layer structure 230 between the second and third films 200 and 300.

The first, second and third transparent films 100, 200 and 300 may include plastic, i.e., polymer resin. In examplary embodiments, the first and third transparent films 100 and 300 may include substantially the same material, and the second transparent film 200 may include a material different from that of the first and third transparent films 100 and 300.

In examplary embodiments, the first and third transparent films 100 and 300 may include silplus, and the second transparent film 200 may include polycarbonate (PC), polyethylene terephthalate (PET), polymethacrylate (PMMA), etc.

Alternatively, the second transparent film 200 may also include a material substantially the same as that of the first and third transparent films 100 and 300.

The first and third transparent films 100 and 300 may have a thickness of, e.g., about 150 μm, and the second transparent film 200 may have a thickness of, e.g., about 180 μm.

The first adhesive layer structure 130 may have a plurality of first adhesive layers. In examplary embodiments, the first adhesive layer structure 130 may have two first adhesive layers 110 and 120, however, may not be limited thereto.

In examplary embodiments, the first adhesive layers 110 and 120 may have substantially the same thickness. For example, the first adhesive layers 110 and 120 may have a thickness of about 5 μm.

In examplary embodiments, the first adhesive layers 110 and 120 may include substantially the same material. For example, the first adhesive layers 110 and 120 may include optically clear adhesive (OCA) or SVR. Alternatively, the first adhesive layers 110 and 120 may include pressure sensitive adhesive (PSA).

The second adhesive layer structure 230 may have a plurality of second adhesive layers. In examplary embodiments, the second adhesive layer structure 230 may have two second adhesive layers 210 and 220, however, may not be limited thereto.

In examplary embodiments, the second adhesive layers 210 and 220 may have substantially the same thickness. For example, the second adhesive layers 210 and 220 may have a thickness of about 5 μm.

In examplary embodiments, the second adhesive layers 210 and 220 may include substantially the same material. For example, the second adhesive layers 210 and 220 may include OCA or SVR. Alternatively, the second adhesive layers 210 and 220 may include PSA.

In examplary embodiments, the first and second adhesive layers 110, 120, 210 and 220 may include substantially the same material, and have substantially the same thickness. Thus, the first and second adhesive layer structures 130 and 230 may have substantially the same material and thickness.

The first window structure 400 in accordance with examplary embodiments may have the plurality of light transparent films 100, 200 and 300, and the first and second adhesive layer structures 130 and 230 including the plurality of first adhesive layers 110 and 120 and the plurality of second adhesive layers 210 and 220, respectively, between the light transparent films 100, 200 and 300. Thus, the first window structure 400 may have an enhanced strength and impact resistance.

The first window structure 400 may have the enhanced strength and impact resistance, and thus the display panel 500 covered by the first window structure 400 may be sufficiently protected, and the first display panel assembly including the display panel 500 and the first window structure 400 may have more stable structure.

FIGS. 2 to 4 are cross-sectional views illustrating a method of manufacturing a first display panel assembly including a first window structure for protecting a display panel. This method may be used in manufacturing the first display panel assembly of FIG. 1, however, may not be limited thereto.

Referring to FIG. 2, a first adhesive layer structure 130 may be formed on a first light transparent film 100.

The first light transparent film 100 may include plastic, i.e., polymer resin. In examplary embodiments, the first light transparent film 100 may include silplus. The first light transparent film 100 may have a thickness of, e.g., about 150 μm.

The first adhesive layer structure 130 may have a plurality of first adhesive layers, and thus the plurality of first adhesive layers may be sequentially stacked on the first light transparent film 100. In examplary embodiments, two first adhesive layers 110 and 120 may be sequentially stacked on the first light transparent film 100.

In examplary embodiments, the first adhesive layers 110 and 120 may include OCA or SVR. Alternatively, the first adhesive layers 110 and 120 may include PSA. Thus, the first adhesive layers 110 and 120 may be adhered to the first light transparent film 100 by sequentially stacking the first adhesive layers 110 and 120 on the first light transparent film 100 and pressing the first adhesive layers 110 and 120.

In examplary embodiments, the first adhesive layers 110 and 120 may have substantially the same thickness. For example, the first adhesive layers 110 and 120 may have a thickness of about 5 μm.

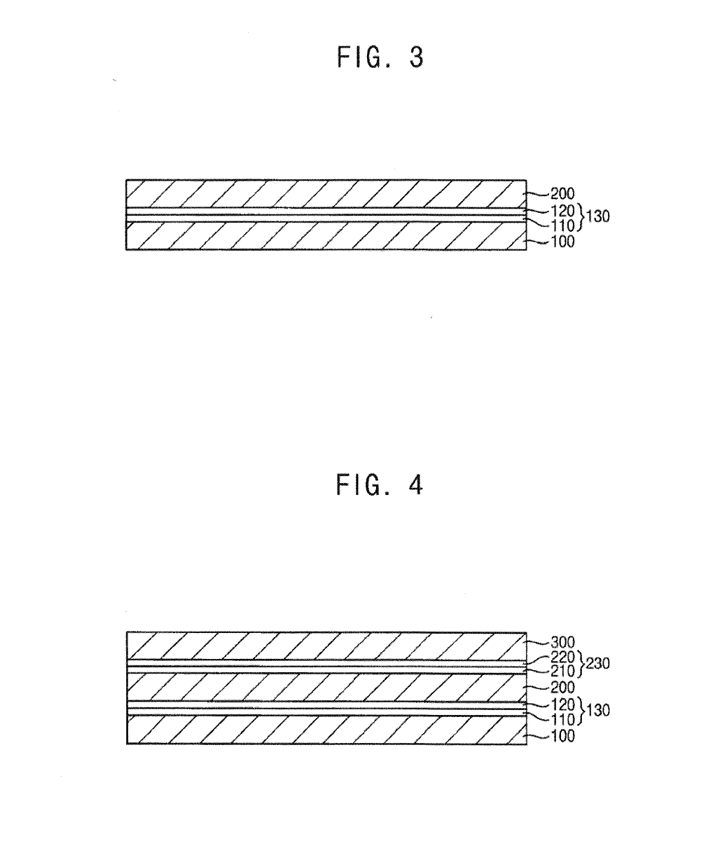

Referring to FIG. 3, a second light transparent film 200 may be adhered to the first adhesive layer structure 130.

In examplary embodiments, after mounting the second light transparent film 200 on the first adhesive layer structure 130, the second light transparent film 200 may be pressed to be adhered to the first adhesive layer structure 130.

The second light transparent film 200 may include plastic, i.e., polymer resin. In examplary embodiments, the second light transparent film 200 may include PC, PET, PMMA, etc. Alternatively, the second light transparent film 200 may include a material substantially the same as that of the first light transparent film 100, e.g., silplus. The second light transparent film 200 may have a thickness of, e.g., about 180 μm.

Referring to FIG. 4, a second adhesive layer structure 230 may be adhered to the second light transparent film 200.

The second adhesive layer structure 230 may include a plurality of second adhesive layers, and thus the plurality of second adhesive layers may be sequentially stacked on the second light transparent film 200. In examplary embodiments, two second adhesive layers 210 and 220 may be sequentially stacked on the second light transparent film 200.

In examplary embodiments, the second adhesive layer 210 and 220 may include a material substantially the same as that of the first adhesive layers 110 and 120. The second adhesive layers 210 and 220 may include, e.g., OCA or SVR. Alternatively, the second adhesive layers 210 and 220 may include PSA. Thus, the second adhesive layers 210 and 220 may be adhered to the second light transparent film by stacking the second adhesive layers 210 and 220 on the second light transparent film 200 and pressing the second adhesive layers 210 and 220.

In examplary embodiments, the second adhesive layers 210 and 220 may have substantially the same thickness. For example, the second adhesive layers 210 and 220 may have a thickness of about 5 μm.

A third light transparent film 300 may be adhered to the second adhesive layer structure 230.

In examplary embodiments, after mounting the third light transparent film 300 on the second adhesive layer structure 230, the third light transparent film 300 may be pressed so that the third light transparent film 300 may be adhered to the second adhesive layer structure 230.

The third light transparent film 300 may include plastic, e.g., polymer resin. In examplary embodiments, the third light transparent film 300 may include silplus. The third light transparent film 300 may include a thickness of, e.g., about 150 μm.

The first, second and third light transparent films 100, 200 and 300, and the first and second adhesive layer structures 130 and 230 may form the first window structure 400.

Referring to FIG. 1 again, the first window structure 400 may be adhered to the display panel 500 to manufacture the first display panel assembly.

The display panel 500 may be, e.g., an OLED display panel, a LCD panel, a PDP, etc.

The first window structure 400 may be adhered to the display panel 500 by a light transparent adhesive, e.g., SVR.

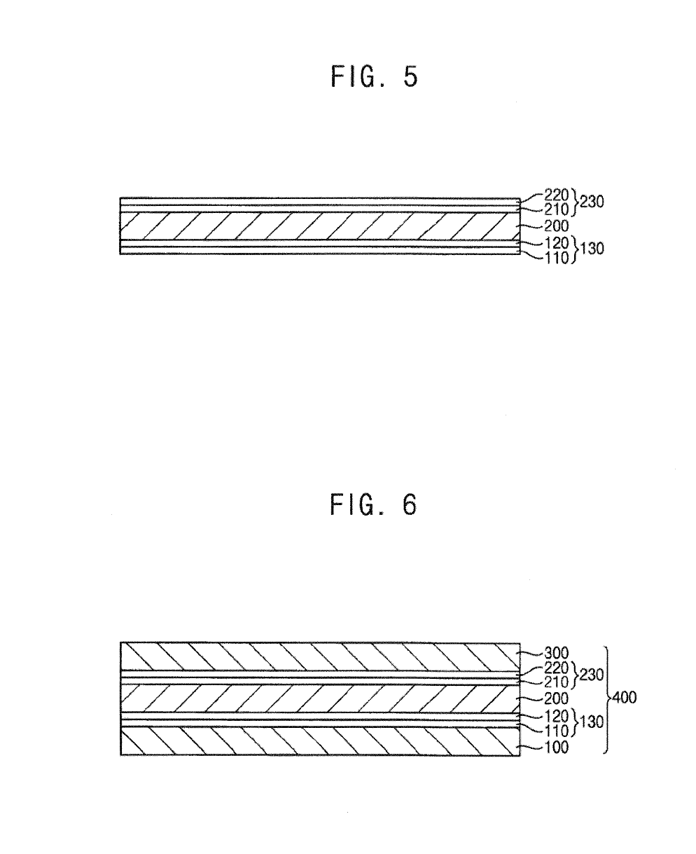

FIGS. 5 and 6 are cross-sectional views illustrating a method of manufacturing a first display panel assembly including a first window structure for protecting a display panel. This method may be used in manufacturing the first display panel assembly, however, may not limited thereto. The method may include processes substantially the same as those illustrated with reference to FIGS. 2 to 4, and thus like reference numerals refer to like elements, and detailed descriptions thereon are omitted herein.

Referring to FIG. 5, first and second adhesive layer structures 130 and 230 may be adhered to bottom and top surfaces of a second light transparent film 200, respectively.

In examplary embodiments, after mounting the first and second adhesive layers 130 and 230 on the bottom and top surfaces of the second light transparent film 200, respectively, the first and second adhesive layers 130 and 230 may be pressed to be adhered to the bottom and top surfaces of the second light transparent film 200.

Referring to FIG. 6, first and third light transparent films 100 and 300 may be adhered to a bottom surface of the first adhesive layer structures 130 and a top surface of the second adhesive layer structures 230, respectively.

In examplary embodiments, after mounting the first and third light transparent films 100 and 300 on he bottom surface of the first adhesive layer structure 130 and the top surface of the second adhesive layer structure 230, respectively, the first and third light transparent films 100 and 300 may be pressed to be adhered to the bottom surface of the first adhesive layer structure 130 and the top surface of the second adhesive layer structure 230.

A process substantially the same as or similar to that illustrated with reference to FIG. 1 may be performed to manufacture the first display panel assembly.

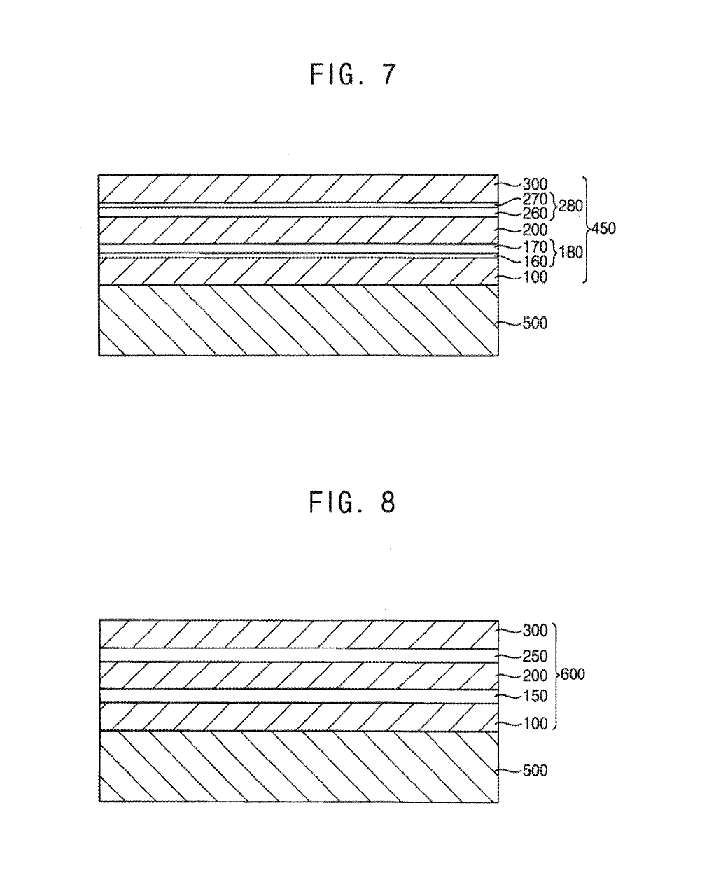

FIG. 7 is a second display panel assembly including a second window structure for protecting a display panel in accordance with examplary embodiments. The display panel assembly may be substantially the same as that illustrated with reference to FIG. 1, except for the thickness of the adhesive layer structure. Thus, like reference numerals refer to like elements, and detailed descriptions thereon are omitted herein.

Referring to FIG. 7, the second display panel assembly may include a display panel 500 and a second window structure 450 on the display panel 500.

In examplary embodiments, the second window structure 450 may include first, second and third light transparent films 100, 200 and 300 sequentially stacked, a third adhesive layer structure 180 between the first and second light transparent films 100 and 200, and a fourth adhesive layer structure 280 between the second and third light transparent films 200 and 300.

The third adhesive layer structure 180 may include a plurality of third adhesive layers. In examplary embodiments, the third adhesive layer structure 180 may include two third adhesive layers 160 and 170, however, may not be limited thereto.

The third adhesive layers 160 and 170 may have different thicknesses from each other. In examplary embodiments, one of the third adhesive layers 160 and 170 (in FIG. 7, the reference numeral 170) that may be closer to the second light transparent film 200 may have a thickness greater than that of the other of the third adhesive layers 160 and 170 (in FIG. 7, the reference numeral 160) that may be closer to the first light transparent film 100. For example, the former may have a thickness of about 7 μm, and the latter may have a thickness of about 3 μm.

The fourth adhesive layers 260 and 270 may have different thicknesses from each other. In examplary embodiments, one of the fourth adhesive layers 260 and 270 (in FIG. 7, the reference numeral 260) that may be closer to the second light transparent film 200 may have a thickness greater than that of the other of the fourth adhesive layers 260 and 270 (in FIG. 7, the reference numeral 270) that may be closer to the third light transparent film 300. For example, the former may have a thickness of about 7 μm, and the latter may have a thickness of about 3 μm.

The second window structure 450 like the first window structure 400 including the plurality of first and second adhesive layers 110, 120, 210 and 220 may have the plurality of third and fourth adhesive layers 160, 170, 260 and 270, and thus may have an enhanced strength and impact resistance.

The second window structure 450 may have the enhanced strength and impact resistance, so that the display panel 500 covered by the second window structure 450 may be sufficiently protected, and the second display panel assembly including the display panel 500 and the second window structure 450 may have a stable structure.

The second display panel assembly like the first display panel assembly may be manufactured by the processes substantially the same as or similar to those illustrated with reference to FIGS. 2 to 4 or 5 to 6.

FIG. 8 is a third display panel assembly including a third window structure for protecting a display panel in accordance with Comparative Example. The display panel assembly may be substantially the same as or similar to those illustrated with reference to FIG. 1 or FIG. 7, except for the adhesive layer structure. Thus, like reference numerals refer to like elements, and detailed descriptions thereon are omitted herein.

Referring to FIG. 8, the third display panel assembly may include a display panel 500 and a third window structure 600 on the display panel 500.

The third window structure 600 may include first, second and third light transparent films 100, 200 and 300 sequentially stacked, a fifth adhesive layer structure 150 between the first and second light transparent films 100 and 200, and a sixth adhesive layer structure 250 between the second and third light transparent films 200 and 300.

The fifth adhesive layer structure 150 may include only one fifth adhesive layer. The fifth adhesive layer may have a thickness of about 10 μm.

In the third window structure 600 unlike the first and second window structures 400 and 450, the fifth and sixth adhesive layers 150 and 250 may have only one fifth and sixth adhesive layers, respectively, and thus the strength or the impact resistance thereof may be decreased when compared to the first and second window structures 400 and 450.

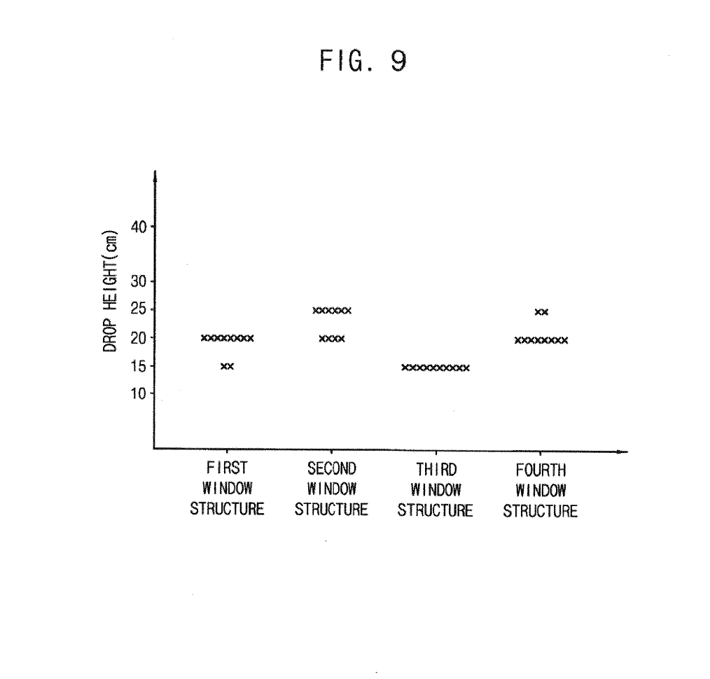

FIG. 9 is a graph illustrating the strength of the first, second, third and fourth window structures. Particularly, FIG. 9 shows the drop height of the window structures at which the window structures are damaged when a ball is dropped onto the window structures having a thickness of about 500 μm.

The first adhesive layer structure of the first window structure includes two first adhesive layers each of which has a thickness of about 5 μm, and the second adhesive layer structure of the first window structure includes two second adhesive layers each of which has a thickness of about 5 μm. Additionally, the third adhesive layer structure of the second window structure includes two third adhesive layers which have a thickness of about 3μm and 5 μm, respectively, and the fourth adhesive layer structure of the second window structure includes two fourth adhesive layers which have a thickness of about 3 μm and 5 μm, respectively. Furthermore, the fifth adhesive layer structure of the third window structure includes one fifth adhesive layer having a thickness of about 10 μm, and the sixth adhesive layer structure of the third window structure includes one sixth adhesive layer having a thickness of about 10 μm.

The fourth window structure may be substantially the same as the first window structure, except that the thicknesses of the adhesive layers are decreased with the same ratio. That is, the first adhesive layer structure of the fourth window structure has two first adhesive layers each of which has a thickness of about 3 μm, and the second adhesive layer structure has two second adhesive layers each of which has a thickness of about 3 μm.

Referring to FIG. 9, the drop height of the third window structure at which the third window structure is damaged was generally lower than that of the second and fourth window structures, i.e., about 15 to about 25 cm.

That is, the first and second window structures in accordance with examplary embodiments had the enhanced strength when compared to the third window structure of Comparative Example. Additionally, the strength of the fourth window structure having a total thickness of about 6 μm was greater than that of the third window structure having a total thickness of about 10 μm.

Thus, the first and second window structures in accordance with examplary embodiments may have the plurality of adhesive layers to have the enhanced strength and impact resistance.

The window structure for protecting a display panel in accordance with examplary embodiments may be applied to various types of electronic devices including a display panel.

The foregoing is illustrative of examplary embodiments, and is not to be construed as limiting thereof. Although a few examplary embodiments have been described, those skilled in the art will readily appreciate that many modifications are possible in the examplary embodiments without materially departing from the novel teachings and advantages of examplary embodiments. Accordingly, all such modifications are intended to be included within the scope of examplary embodiments as defined in the claims. In the claims, means-plus-function clauses are intended to cover the structures described herein as performing the recited function and not only structural equivalents but also equivalent structures. Therefore, it is to be understood that the foregoing is illustrative of examplary embodiments and is not to be construed as limited to the specific embodiments disclosed, and that modifications to the disclosed examplary embodiments, as well as other examplary embodiments, are intended to be included within the scope of the appended claims. The invention is defined by the following claims, with equivalents of the claims to be included therein.

1. A window structure, comprising:
first, second and third light transparent films sequentially stacked on a display panel;
a first adhesive layer structure between the first and second light transparent films, the first adhesive layer structure including a plurality of first adhesive layers; and
a second adhesive layer structure between the second and third light transparent films, the second adhesive layer structure including a plurality of second adhesive layers.

2. The window structure of claim 1, wherein the plurality of first adhesive layers has substantially the same thickness, and the plurality of second adhesive layers has substantially the same thickness.

3. The window structure of claim 2, wherein the first and second adhesive layers have substantially the same thickness.

4. The window structure of claim 1, wherein the first and second adhesive layer structures have two first adhesive layers and two second adhesive layers, respectively.

5. The window structure of claim 4, wherein one of the first adhesive layers adjacent to the second light transparent film has a thickness greater than that of the other of the first adhesive layers adjacent to the first light transparent film, and
wherein one of the second adhesive layers adjacent to the second light transparent film has a thickness greater than that of the other of the second adhesive layers adjacent to the third light transparent film.

6. The window structure of claim 1, wherein the plurality of first adhesive layers has substantially the same material, and the plurality of second adhesive layers has substantially the same material.

7. The window structure of claim 6, wherein the first and second adhesive layers includes substantially the same material.

8. The window structure of claim 7, wherein the first and second adhesive layers include optically clear adhesive (OCA) or super view resin (SVR).

9. The window structure of claim 7, wherein the first and second adhesive layers include pressure sensitive adhesive (PSA).

10. The window structure of claim 1, wherein the first and third light transparent films have substantially the same material, and the second light transparent film has a material different from that of the first and third light transparent films.

11. The window structure of claim 10, wherein the first and third light transparent films include silplus, and the second light transparent film include polycarbonate (PC), polyethylene terephthalate (PET) or polymethyl methacrylate (PMMA).

12. A display panel assembly, comprising:
a display panel; and
a window structure on the display panel, the window protecting the display panel, the window structure including:
first, second and third light transparent films sequentially stacked on the display panel;
a first adhesive layer structure between the first and second light transparent films, the first adhesive layer structure including a plurality of first adhesive layers; and
a second adhesive layer structure between the second and third light transparent films, the second adhesive layer structure including a plurality of second adhesive layers.

13. The display panel assembly of claim 1, wherein the first and second adhesive layer structures have two first adhesive layers and two second adhesive layers, respectively, and
the first and second adhesive layers have substantially the same thickness.

14. The window structure of claim 12, wherein the first and second adhesive layers have two first adhesive layers and two second adhesive layers, respectively,
wherein one of the first adhesive layers adjacent to the second light transparent film has a thickness greater than that of the other of the first adhesive layers adjacent to the first light transparent film, and
wherein one of the second adhesive layers adjacent to the second light transparent film has a thickness greater than that of the other of the second adhesive layers adjacent to the third light transparent film.

15. The window structure of claim 12, wherein the first and second adhesive layers include PSA,
wherein the first and third light transparent films include silplus, and
wherein the second light transparent film includes PC, PET or PMMA.

16. A method of manufacturing a window structure for protecting a display panel, comprising:
adhering a first adhesive layer structure on a first light transparent film, the first adhesive layer structure including a plurality of first adhesive layers;
adhering a second light transparent film on the first adhesive layer structure;
adhering a second adhesive layer structure to the second light transparent film, the second adhesive layer structure including a plurality of second adhesive layers; and
adhering a third light transparent to the second adhesive layer structure.

17. The method of claim 16, wherein adhering the first and second adhesive layer structures to the first and second light transparent films, respectively, includes forming two first adhesive layers and two second adhesive layers, and
wherein the first and second adhesive layers have substantially the same thickness.

18. The method of claim 16, wherein adhering the first and second adhesive layer structures to the first and second light transparent films, respectively, includes forming two first adhesive layers and two second adhesive layers,
wherein a thinner one of the first adhesive layers is adhered to a top surface of the first light transparent film and a thicker one of the first adhesive layers is adhered to a bottom surface of the second light transparent film, and
wherein a thicker one of the second adhesive layers is adhered to a top surface of the second light transparent film and a thinner one of the second adhesive layers is adhered to a bottom surface of the third light transparent film.

19. The method of claim 16, wherein the first and second adhesive layers are formed to include PSA,
wherein the first and third light transparent films are formed to include silplus, and
wherein the second light transparent film is formed to include PC, PET or PMMA.

20. A method of manufacturing a display panel assembly, comprising:
adhering a first adhesive layer structure on a first light transparent film, the first adhesive layer structure including a plurality of first adhesive layers;
adhering a second light transparent film on the first adhesive layer structure;
adhering a second adhesive layer structure to the second light transparent film, the second adhesive layer structure including a plurality of second adhesive layers;
adhering a third light transparent to the second adhesive layer structure; and
adhering the first light transparent film to a display panel.

21. The method of claim 20, wherein adhering the first and second adhesive layer structures to the first and second light transparent films, respectively, includes forming two first adhesive layers and two second adhesive layers, and
wherein the first and second adhesive layers are formed to have substantially the same thickness.

22. The method of claim 20, wherein adhering the first and second adhesive layer structures to the first and second light transparent films, respectively, includes forming two first adhesive layers and two second adhesive layers,
wherein a thinner one of the first adhesive layers is adhered to a top surface of the first light transparent film and a thicker one of the first adhesive layers is adhered to a bottom surface of the second light transparent film, and
wherein a thicker one of the second adhesive layers is adhered to a top surface of the second light transparent film and a thinner one of the second adhesive layers is adhered to a bottom surface of the third light transparent film.

23. The method of claim 20, wherein the first and second adhesive layers are formed to include PSA,
wherein the first and third light transparent films are formed to include silplus, and
wherein the second light transparent film is formed to include PC, PET or PMMA.
